(19) United States
(12) Patent Application Publication
(10) Pub. No.: US 2007/0201946 A1
(43) Pub. Date: Aug. 30, 2007

(54) Clamp assembly and related methods

(76) Inventor: Charles C. Sammann, Amarillo, TX (US)

Correspondence Address: J. Mark Holland & Associates, 3 San Joaquin Plaza, Suite 210, Newport Beach, CA, 92660, US

(21) Appl. No.: 11/361,134

(22) Filed: Feb. 24, 2006

(51) Int. Cl. F16B 12/46

(52) U.S. Cl. 403/403

(57) ABSTRACT

The present invention describes a clamp assembly configured to join elongate members, preferably, among others, lengths of wood beam in various configurations. In one embodiment, the clamp assembly includes a pair of gripping members each having a generally planar surface positioned in a confronting relationship and configured to receive therebetween the marginal ends of first and second elongate members spaced apart at an angle from each other. At least one of the gripping members further includes a cradle extending outward and perpendicular (or at some other angle) to a top edge of the gripping member's generally planar surface. Where two or more such gripping members have cradle elements, they can be positioned, among other things, in a direction opposite or parallel to the other cradle. In such alignments, each cradle can receive a length of a third elongate member, such that the third elongate member, and the first and second elongate members are joined to each other. The gripping members are joined to or otherwise held in assembly with the elongate members by any suitable means. Other embodiments include, without limitation, using only one such gripping or clamp member to join the beams (which would not as strong as two or more members for a joint, but maybe strong enough for some applications). For such single clamp embodiments or other applications, extra long lag bolts or similar means can be used to assemble the single clamp to the beam members.

### FIELD OF THE INVENTION

The present invention relates generally to a clamp assembly, and more particularly to a clamp assembly configured to join elongate members, preferably, among others, lengths of wood beam in various configurations. The clamp assembly has particular utility in the construction of activity systems for children such as playgrounds including treehouses, swing-sets, and play-sets.

### BACKGROUND OF THE INVENTION

Brackets, clamp assemblies, and the like, typically used to join one or more elongate members exist in various forms and serve a variety of purposes. On such example of a clamp assembly for joining elongate members is disclosed in U.S. Pat. No. 5,403,110, issued to Sammann, the content of which is hereby incorporated by reference.

### SUMMARY OF THE INVENTION

The present invention describes a clamp assembly configured to join elongate members, preferably, among others, lengths of wood beam in various configurations. The clamp assembly has particular utility in the construction of commercial, public, and/or residential activity systems for children such as playgrounds, including swing-sets and play-sets. However, the clamp assembly, as described herein, is equally suitable for use in a variety of applications where the joining of elongate members is desired.

In one embodiment, the clamp assembly includes a pair of gripping members each having a generally planar surface positioned in a confronting relationship and configured to receive therebetween the marginal ends of first and second elongate members spaced apart at an angle from each other.

In a preferred embodiment, the first and second elongate members are arranged in a generally “A” shaped angle configuration. Said angle may be predetermined or assembled prior to installation. Alternatively, said angle may be determined on-site. Persons skilled in the art will recognize that allowing for alternative angles will provide additional flexibility for varied terrain and/or different lengths of the first and second elongate members.

Each gripping member further includes a cradle formed on the top edge of the generally planar surface. Preferably, each cradle, formed as a flat or generally planar surface, extends perpendicular to its respective top edge in a direction opposite to the other cradle so that each cradle receives a length of a third elongate member such that the third elongate member, and the first and second elongate members are joined in a “squared” relationship relative to each other as described below. Preferably, the generally planar surface of each cradle further includes oppositely positioned first and second sides extending therefrom for contacting a portion of the third elongate member.

Also preferably, each gripping member includes a plurality of orifices, gripping teeth, or other elements to facilitate connection to the respective beam members. Where orifices or openings are provided, they preferably are configured to receive a one or more of a corresponding plurality of connecting means (bolt and nut, screw, or similar type fastener) therethrough for connecting/securing the gripping members and the elongate members together. In this regard, a bolt may pass through the entire clamp assembly to receive a nut. Tightening of the nut on the bolt secures the structure together. Alternatively, screws, if used, may only need to pass through one of the gripping members as they typically hold the structure by burrowing into the elongate member. Glue, cement, or other adhesives or connecting means can be used in alternative embodiments.

A top plate is preferably included and positioned along a section of the third elongate member. Preferably, the top plate includes oppositely positioned first and second sides extending therefrom so as to contact a portion of the third elongate member. Preferably, orifices are included in the top plate to receive connection means such as those indicated above. In this regard, a corresponding bolt or other connection means is intended to pass through the top plate, the third elongate member, and a corresponding cradle to secure the third elongate member therebetween.

For the purpose of summarizing the invention certain objects and advantages have been described herein. It is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

These and other embodiments will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 shows a gripping member for joining elongate members in accordance with one embodiment of a clamp assembly of the present invention.

FIG. 2 shows the clamp assembly of FIG. 1, with corresponding first and second elongate members received between corresponding gripping members. It is also similar to section 2 in FIG. 8, with the third beam or cross member removed.

FIG. 3 shows the gripping member of FIG. 2, each having a cradle for receiving a third elongate member, and a top plate for securing the third elongate member between the cradles and top plate in a “squared” relationship relative to the first and second elongate members.

FIGS. 4(A)-(B) show two views of the top plate of FIG. 3. FIG. 4(A) is a perspective view from the same angle as FIG. 3; FIG. 4(B) is a perspective view from a similar angle but with the top plate flipped over and opening upwardly.

FIG. 5 shows a clamp assembly for joining first and second elongate members, including gripping members each having a cradle angled relative to each other for receiving a third elongate member in accordance with an alternative embodiment of the present invention.

FIG. 6 shows the clamp assembly of FIG. 5, with corresponding first and second elongate members received between corresponding gripping members.

FIG. 7 shows the gripping member of FIG. 6, joining, first, second and third elongate member in a “skewed” relationship.

FIG. 8 shows the clamp assembly of FIG. 1, joining first, second, and third elongate members of a play-set in a “squared” relationship.

FIG. 9 shows a clamp assembly for joining elongate members utilizing an alternative embodiment of the clamp assembly in accordance with the present invention.

FIG. 10 shows still another embodiment of a clamp assembly for joining a pair of elongate members in accordance with the present invention.

FIGS. 11A-I are plan views of some of the many patterns in which blanks of metal or other material for the clamp member of the invention may be cut and/or formed, prior to bending along the dashed lines. For example, 11F illustrates a metal plate prior to folding that, when folded, can clamp and/or join three beams to one another, each on a separate axis. FIG. 11J shows a blank of Applicant's top plate.

### DETAILED DESCRIPTION

Embodiments of the present invention will now be described with references to the accompanying Figures. The terminology used in the description presented herein is not intended to be interpreted in any limited or restrictive manner, simply because it is being utilized in conjunction with a detailed description of certain embodiments of the invention. Furthermore, various embodiments of the invention may include novel features, no single one of which is solely responsible for its desirable attributes or which is essential to practicing the invention herein described.

Much of the detailed description focuses on a clamp assembly for use in activity systems for children such as playgrounds including swing sets and play-sets. However, the clamp assembly as described is suitable for use in a variety of applications where the joining of elongate members in various configurations is desired.

A clamp assembly 5, in accordance with one embodiment of the invention, includes a pair of gripping members 10, 15 each being substantially the same size and shape. In this regard, one gripping member 10 is preferably interchangeable with the other similarly configured gripping member 15. Accordingly, in regard to the pair of gripping members 10, 15, unless otherwise indicated, the detailed description relating to any one gripping member 10 applies equally to the other gripping member 15.

Gripping members 10, 15 are preferably constructed from a single sheet of metal folded, bent, or otherwise formed accordingly. Alternatively, depending on load stress and other design application requirements, plastic and materials other than metal or plastic may be used in construction of the gripping members.

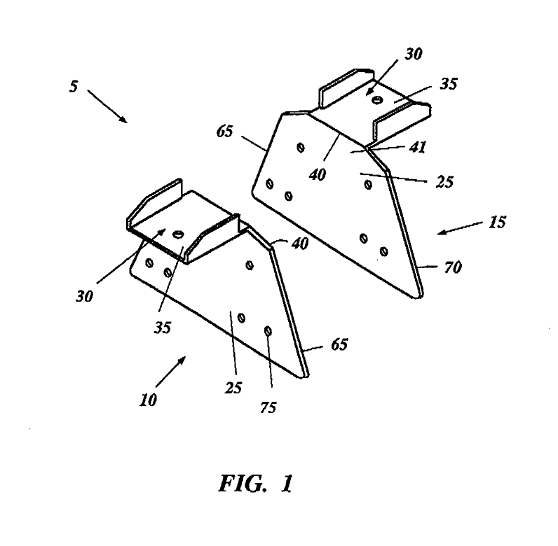

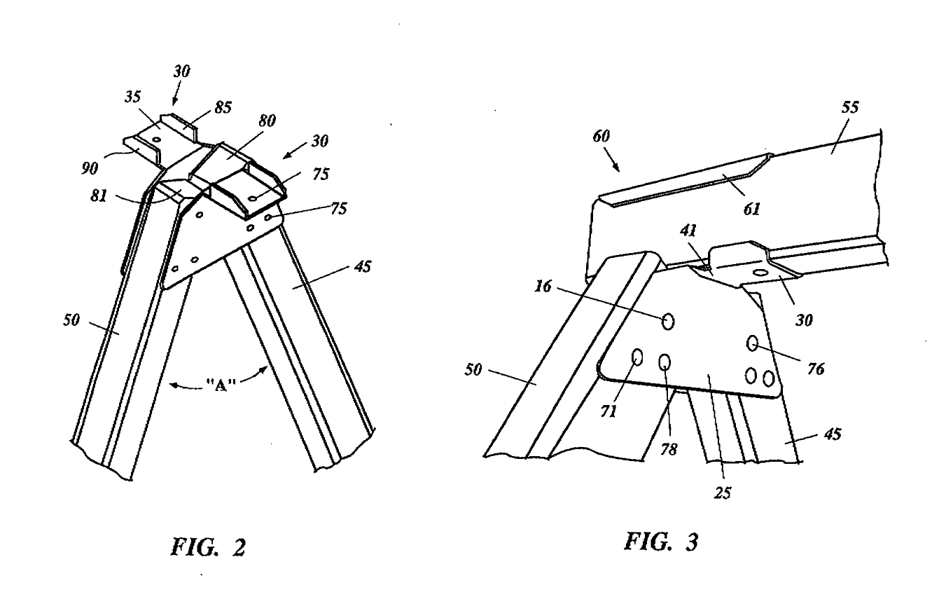

As shown in FIG. 1, each gripping member 10, 15 includes a generally planar surface 25 having angled sides 65, 70. In a preferred embodiment, two such generally planar surfaces 25 are positioned in a confronting relationship and configured to receive therebetween first and second elongate members 45, 50 spaced apart at an angle “A” (FIGS. 2 and 8) from each other. Each gripping member 10, 15 further includes a cradle 30 formed along a top edge 40 of the generally planar surface 25. The cradle 30, a flat or generally planar surface 35, may extend directly from the top edge 40 and perpendicular to the generally planar surface 25 in a direction opposite to the other cradle 30 so that each cradle receives a length of a third elongate member 55 thereby joining the elongate members 45, 50, 55 together in a “squared” relationship, as shown in FIGS. 3, and 8. Preferably, an extension 41 is included between the top edge 40 of the pocket 20 and the cradle 30. The extension 41 may facilitate bending of the cradle relative to the pocket 20 during the manufacturing process.

When used to construct an activity system 60 such as the play-set shown in FIG. 8, elongate members 45, 50 (typically wood beams) are positioned at an angle “A” from each other. This angle “A” typically corresponds to the angled sides 65, 70 of the generally planar surfaces 25 configured to receive the first and second elongate members 45, 50 therebetween.

The generally planar surfaces 25 may further include one or more orifices 75 to receive a connecting means (not shown), such as a bolt/nut, screw, or similar type fastener, therethrough to facilitate installation by further connecting/securing the generally planar surfaces 25 and elongate members 45, 50 together. In this regard, in one embodiment, a first connecting means, such as bolt 76, is positioned through each gripping member 10, 15 and corresponding first and second elongate members 45, 50 to act as a pivot point to facilitate angled positioning of the elongate members 10, 15. Other connection means, such as other bolts 77, 78, may then be utilized to finalize securing of the elongate members 45, 50 and gripping members 10, 15 together. Any suitable means may be used to join or help secure the clamp assembly and the beams, including glue or other adhesives, “teeth” formed in the clamp elements, etc.

In a preferred embodiment, the generally planar surfaces 25 are configured to receive the marginal end 80, 81 of the first and second elongate members 45, 50. However, as shown in FIG. 9, in certain applications the clamp assembly may be modified by elongating or lengthening the generally planar surface 25 to receive a medial section 82, 83 of the first and second elongate members 45, 50, thereby allowing a third elongate member 55 to pass between or even under the first and second elongate members 45, 50.

As shown in FIG. 3, the third elongate member 55 is typically placed into each of the cradles 30. The cradle 30 preferably includes oppositely positioned first and second sides or web elements 85, 90 extending therefrom for contacting a portion of the third elongate member 55 as well as orifices 75 to receive a connecting means (not shown), such as a bolt/nut, screw, or similar type fastener, therethrough to facilitate installation by connecting/securing the cradle 30 and the third elongate member 55 together.

Preferably, as shown in FIGS. 2 and 3, the generally planar surface 35 of the cradle 30 extends outward, perpendicularly (at a right angle) to the generally planar surface, and in an opposite direction to the other cradle such that the third elongate member 55, and the first and second elongate members 45, 50 are joined in a “squared” relationship relative to each other. Among the many benefits of the invention, the cradle 30 eliminates the need to cut the top (medial end) of the angled legs with an angled cut to facilitate receiving the third elongate member 55.

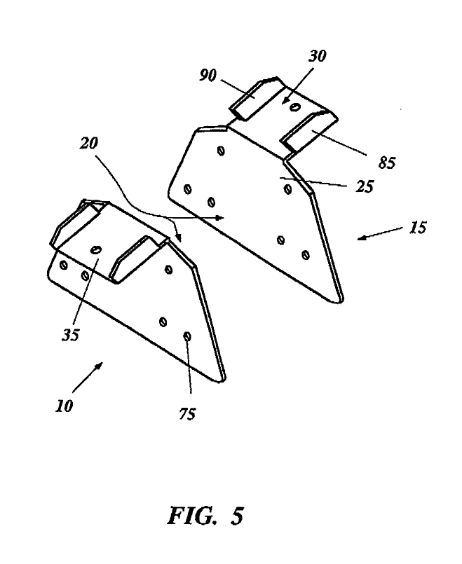

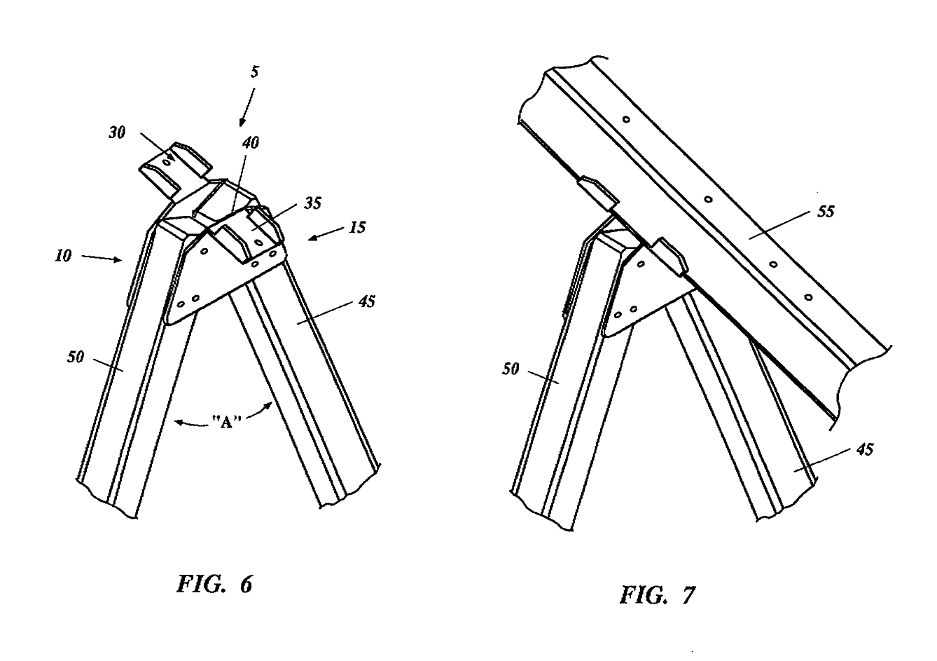

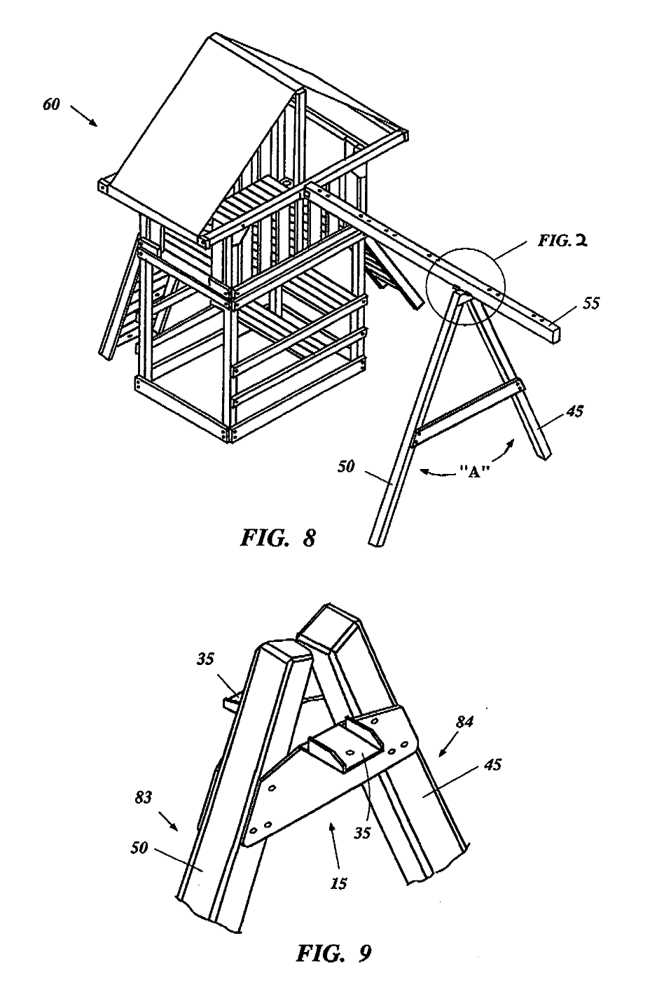

Alternatively as shown in FIGS. 5-7, for certain applications the generally planar surface 35 of the cradle 30 may extend at some angle other than at a right angle or perpendicular to the pocket 20 such that the third elongate member 55, and the first and second elongate members 45, 50 are joined in a “skewed” relationship. Moreover, for beams that are not square or rectangular in cross-section, the clamp elements can be modified to abut the relevant beam surfaces.

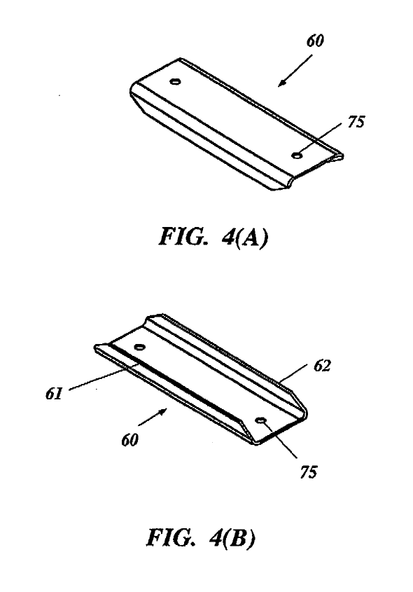

As shown in FIG. 3, and more specifically in FIGS. 4(A)-(B), a top plate 60 may be included and positioned along a section of the third elongate member 55. Preferably, the top plate 60 includes oppositely positioned first and second sides 61, 62 extending therefrom so as to contact a portion of the third elongate member 55. Preferably, orifices 75 are included in the top plate 60 to receive connection means such as those indicated above. In this regard, a corresponding connection means is intended to pass through the top plate 60, third elongate member 55, and corresponding cradles 30 to secure the third elongate member 55 therebetween.

Methods of the invention include providing beams or elongate elements and joining them in desired spatial relationships using clamp elements of the type described above. Among other things, such methods can reduce the costs and time required to fabricate and assemble a desired joint between the elongate elements.

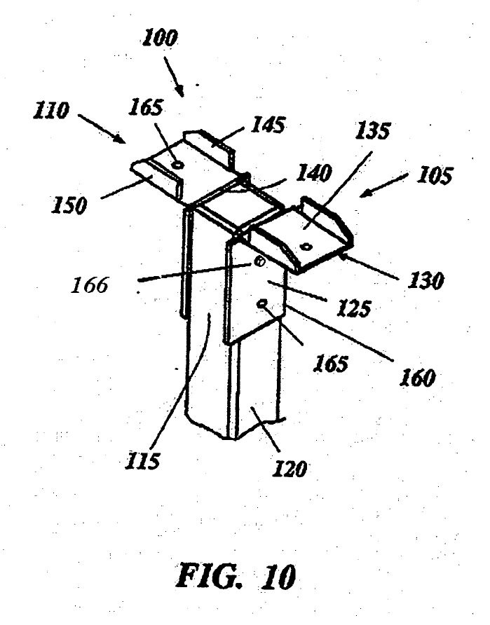

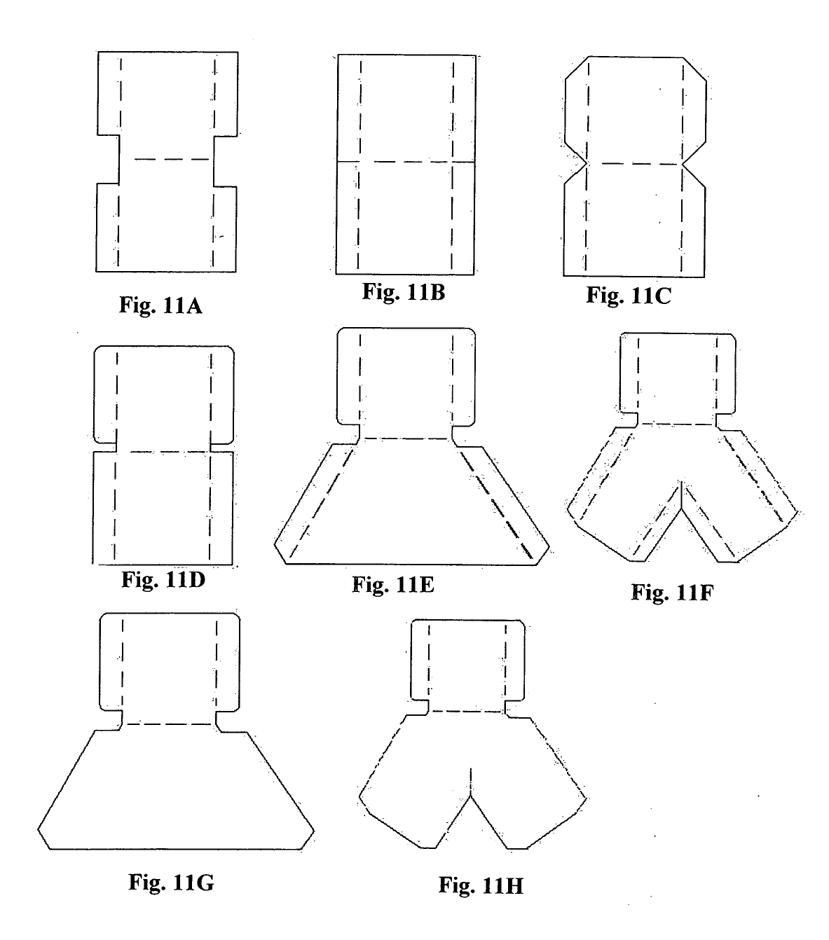

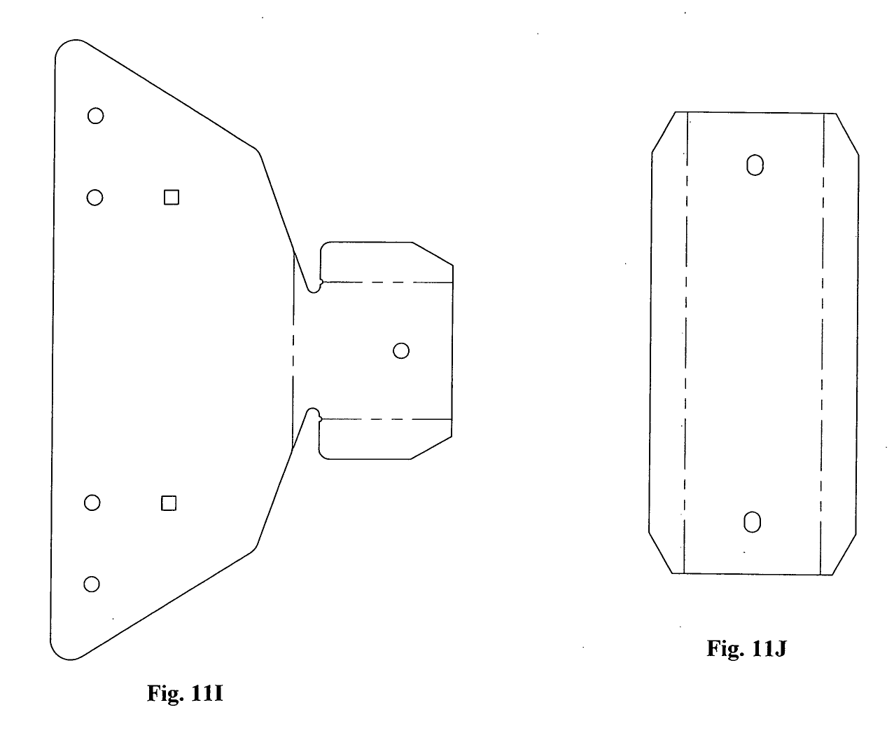

Another of the many alternative embodiments of the invention is shown in FIG. 10, in which the basic concept of a clamp assembly 5 having a dual gripping member 10, 15 configuration for receiving elongate members of various widths, as described herein, may be applied equally to a clamp assembly 100 having a pair of gripping members 105, 110 each having a generally planar surface 125 for receiving a single elongate member 120. In this regard, similar to the previously discussed embodiment, preferably, one gripping member 105 is substantially the same size and shape as the other gripping member 110. The generally planar surfaces 125 are positioned in a confronting relationship and configured to receive therebetween a marginal end of a first elongate member 120. Each gripping member 105, 110 further includes a cradle 130 having a generally planar surface 125 formed on the edge of a first side 140 of the generally planar surface 125 and extending therefrom and in a direction opposite to the other cradle so that each cradle receives a length of a second elongate member (not shown) and thereby join the elongate members together.

Preferably, the generally planar surface 125 of each cradle 130 is positioned at a right angle to the top edge 140 and in an opposite direction to each other such that the first and the second elongate members are joined in a “squared” relationship relative to each other. The cradle 130 preferably further includes oppositely positioned first and second sides 145, 150 extending therefrom for contacting a portion of the second elongate member. Among the many alternative embodiments of the invention, however, the cradles can be parallel to each other but at a non-perpendicular angle with respect to the first beam or elongate member. Likewise, the cradles can extend in the same direction as each other, and for some applications, a single clamp element may provide sufficient support (rather than requiring a pair of such elements).

As noted above, any of a wide range of suitable methods (or combination thereof) of joining the elongate elements to each other using the clamp element or elements may be employed. Bands or straps may be placed around the “arms” of the assembly, holding the various opposing planar clamping surfaces in compression on opposite sides of the beams. Adhesives or gripping “teeth” in the clamping elements may be used. The generally planar surfaces 125 may further include one or more orifices 165 to receive a connecting means, such as a bolt/nut 166, screw, or similar type fastener, therethrough to facilitate installation by further connecting/securing the generally planar surfaces 125 and elongate members together.

Some of the other many alternative embodiments of the invention include 4^{th} beam (parallel, aligned, or misaligned with the third beam). 5^{th} and/or sixth beams

The apparatus and methods of the present invention have been described with some particularity, but the specific designs, constructions and steps disclosed are not to be taken as limiting of the invention. Obvious modifications will make themselves apparent to those of ordinary skill in the art, all of which will not depart from the essence of the invention, and all such changes and modifications are encompassed within the appended claims.

What is claimed is:

1. A clamp assembly for joining elongate members, comprising:
a pair of gripping members each having a generally planar surface positioned in a confronting relationship and configured to receive therebetween first and second elongate members spaced apart at an angle from each other, each gripping member further including a cradle having a generally planar surface extending from a top edge of the planar surface, the cradle extending therefrom and in a direction opposite to the other cradle so that each cradle is capable of receiving a length of a third elongate member to thereby join the elongate members together.

2. The clamp assembly of claim 1, wherein the generally planar surface of each cradle extends generally perpendicularly to the generally planar surface confronting the first and second elongate members, such that the third elongate member is generally perpendicular to the first and second elongate members.

3. The clamp assembly of claim 1, wherein the generally planar surface of each cradle further includes oppositely positioned first and second sides extending therefrom for contacting a portion of the third elongate member.

4. The clamp assembly of claim 1 or claim 2 or claim 3, wherein the generally planar surfaces of each gripping member receive marginal ends of the first and second elongate members.

5. A clamp assembly for joining elongate members, comprising:
a pair of gripping members each including a generally planar surface having angled sides, the planar surfaces positioned in a confronting relationship for receiving therebetween a first elongate member and a second elongate member spaced apart at an angle from each other, the angled sides each forming a pocket that is angled substantially the same as the first and second elongate members, each gripping member further including a cradle formed by a generally planar surface extending from a top edge of the planar surface in a direction opposite the other cradle to receive a length of a third elongate member.

6. The clamp assembly of claim 5, wherein the generally planar surface of each cradle extends perpendicular to its respective top edge such that the third elongate member, and the first and second elongate members are joined in a squared relationship relative to each other.

7. The clamp assembly of claim 6, wherein the generally planar surface of each cradle further includes oppositely positioned first and second sides extending therefrom for contacting a portion of the third elongate member.

8. A clamp assembly for joining elongate members, comprising:
a pair of gripping members each having a first generally planar surface, the pair of such surfaces configured to receive therebetween in a confronting relationship a marginal end of a first elongate member, each gripping member further including a second generally planar surface forming an angle with its respective first planar surface, said second planar surfaces being generally parallel with each other and configured to abut in a confronting relationship a length of a second elongate member; and
means to join the elongate members in a fixed relationship to each other using the pair of gripping members.

9. The clamp assembly of claim 8, wherein each second surface extends perpendicular from the top edge of its respective first surface, such that the first and the second elongate members are joined in a squared relationship relative to each other.

10. The clamp assembly of claim 9, wherein each second generally planar surface further includes oppositely positioned first and second sides extending at an angle therefrom, said sides configured and positioned to contact a portion of the second elongate member.

11. Apparatus for joining elongate members, comprising:
a clamp member having a first generally planar surface sized and configured to abut the sides of a first elongate member and a second elongate member that are positioned at a desired relationship with each other, the clamp member further including a second generally planar surface extending from the first generally planar surface, said second generally planar surface sized and configured to abut the side of a third elongate member positioned in a desired relationship with the first and second elongate members; and
attachment means for holding the clamp member and the first and second and third elongate members in the desired relationship with each other.

12. The apparatus of claim 11, including at least one angled side extending from said generally planar surface, said angled side positioned and angled and dimensioned to assist in retaining an elongate member in a desired relationship with the clamp.

13. The apparatus of claim 12, including a plurality of such angled side elements.

14. The apparatus of claim 12 or claim 13, in which gripping elements are provided in the clamp to facilitate engagement between the clamp member and the elongate member.

15. A method of assembling a plurality of elongate members to each other, including the steps of:
providing a plurality of elongate elements;
providing at least one apparatus of claim 11;
affixing said apparatus to said elongate elements, to hold said elongate elements in a desired spatial relationship with each other.

16. The method of claim 15, including the steps of
providing a plurality of apparatus of claim 11: and
affixing said apparatus to said elongate elements, to hold said elongate elements in a desired spatial relationship with each other.

17. Apparatus for joining two elongate members, comprising:
a clamp member having a first generally planar surface sized and configured to abut the side of a first elongate member, the clamp member further including a second generally planar surface extending at an angle from the first generally planar surface, said second generally planar surface sized and configured to abut the side of a second elongate member positioned in a desired relationship with the first elongate member; and
attachment means for holding the clamp member and the first and second elongate members in the desired relationship with each other.

18. The apparatus of claim 17, in which said first elongate member is a generally vertical wooden post and said second elongate member is a generally horizontal wooden beam.

19. The apparatus of claim 18, including at least one web element extending from said first generally planar surface to abut another side of said first elongate member.

20. The apparatus of claim 18 or claim 19, including at least one web element extending from said second generally planar surface to abut another side of said second elongate member.

21. The apparatus of claim 17 or claim 18, including a second such clamp member affixed to the first and second elongate members, with said clamp members being positioned on generally opposite sides of said first elongate member.

22. The apparatus of claim 17, further including a top plate member configured and positioned to abut said second elongate member on a side generally opposite said second generally planar surface and configured to receive at least one bolt element, said bolt element sized and configured to pass through said top plate member and through the second generally planar surface, and nut means for retaining said bolt in its desired relationship with said top plate and said second generally planar surface.

23. A children's playset, including:
a plurality of beams;
at least one clamp member having a first generally planar surface sized and configured to abut the side of a first beam, the clamp member further including a second generally planar surface extending at an angle from the first generally planar surface, said second generally planar surface sized and configured to abut the side of a second beam positioned in a desired relationship with the first beam; and
means for affixing the clamp member and the first and second beams in the desired relationship with each other.

24. A metal blank for a clamp member, said blank including:
a body portion having a first generally planar section configured to abut at least one beam element and be affixed thereto, said body portion having a second generally planar section configured to abut at least a second beam element and be affixed thereto, said generally planar sections configured to allow a bend to be formed between them so that they are in different planes from each other, each of said planar sections having at least one wing portion extending therefrom and not connected to the other planar section, said wing portion configured to allow a bend to be formed between itself and its respective planar section and to abut the respective first or second beam element.

25. The clamp assembly of claim 1 or claim 5 wherein the first and second elongate members are arranged at a predetermined angle.
